(19) United States
(12) Patent Application Publication
(10) Pub. No.: US 2026/0018803 A1
(43) Pub. Date: Jan. 15, 2026

(54) A MULTI-BEAM ANTENNA AND A METHOD FOR MANUFACTURING A MULTI-BEAM ANTENNA

(71) Applicant: RHEINISCH-WESTFÄLISCHE TECHNISCHE HOCHSCHULE (RWTH) AACHEN, Aachen (DE)

(72) Inventor: Mohammed ARIF, Aachen (DE)

(73) Assignee: RHEINISCH-WESTFÄLISCHE TECHNISCHE HOCHSCHULE (RWTH) AACHEN, Aachen (DE)

(21) Appl. No.: 18/992,456

(22) PCT Filed: May 23, 2023
(86) PCT No.: PCT/EP2023/063757

§ 371 Date: Jan. 8, 2025

(30) Foreign Application Priority Data
Jul. 14, 2022 (DE) 102022117628.2

(51) Int. Cl. H01Q 21/00; H01Q 15/00; H01Q 21/06; H01Q 25/00

(52) U.S. Cl. CPC H01Q 21/0037; H01Q 15/0086; H01Q 21/061; H01Q 25/00

(57) ABSTRACT

A multi-beam antenna (1), comprising: a substrate(S); a metasurface on the substrate(S) formed as a matrix having rows (6) and columns (4, 5) of unit cells of first (2) and second (3) types, the multi-beam antenna (1) being adapted to radiate phase-adjusted signals in multiple directions simultaneously based on a periodic arrangement of the unit cells of the first (2) and second (3) types on the substrate(S).

### TECHNICAL FIELD

The invention relates to a multi-beam antenna having the features of the generic term in claim 1, and to a method of manufacturing such an antenna.

The following background is intended only to provide information necessary to understand the context of the inventive ideas and concepts disclosed herein. Therefore, this background section may include patentable subject-matter and should not be considered prior art per se.

### BACKGROUND

The demand for mobile broadband is growing rapidly; technological applications such as the Internet of Things (IoT) and machine-to-machine (M2M) communication are also experiencing continuous development. This market demand has led to an increase in the number of base stations, antennas and antenna masts, resulting in high CAPEX and OPEX. Multi-beam antennas (so-called multibeam antennas) play an important role in solving these problems as they can fulfill the function of multiple antennas in a single device.

Typically, mobile operators use three sectors in a 360° coverage area. As a result, many antenna masts are currently overcrowded with 4G and 5G antennas. Finding more space on the antenna masts for the emerging 5G and 6G technologies and reducing the number of base station locations in cities is a task for the future. In addition, creating multiple narrow beams, improving spectral efficiency and increasing the capacity of wireless network systems by enabling the reuse of spectrum resources within a determined range without degrading signal quality due to self-interference is a future task.

The signal quality (SNR) in tall buildings is usually poor because the top floors receive many signals from different base stations at the same time, which interfere with each other. As a result, the data rate and voice quality deteriorate. Mobile operators are usually forced to use many antennas with different tilts/angles to optimize coverage in terms of elevation and azimuth planes.

Cell phones are operated with different technologies, e.g. 3G, 4G, 5G, WiFi and GPS. They are already overloaded, getting smarter and more compact; therefore, more compact antennas are desirable. The new 5G standard uses the millimeter wave bands to provide broadband services. However, the path loss in these bands is very high. Therefore, highly directional and narrowly steerable beams are needed to compensate for the path loss. Conventional phased array antennas are difficult to install in cell phones due to their limited size. In addition, phased array antennas are integrated with a phase shifter and digital beamforming to enable the multi-beam steering function, requiring more power and size.

An efficient multi-beam structure is also needed in microwave imaging, such as for security control systems and medical diagnostics. Conventional prior art is either a mechanical raster scan or a phased array antenna system. Mechanical raster scanning is slow and bulky as it scans from point to point, while the phased array antenna system requires full phase control for each antenna. According to the Nyquist limit, thousands of antenna elements are required to scan human body size in the millimeter range, with each clement requiring a separate RF circuit (e.g. phase shifter, power amplifier). This leads to a complex, costly and energy-intensive architecture for beam steering.

Phased array antenna systems also require a large number of input ports with dedicated feed networks. Common types of feed networks are Butler Matrix, Luneburg and Rotman lens. However, all of them can only achieve predefined beam angles, are complex and bulky. Most phased array antenna systems also have RF gain controller components (either attenuators or variable gain amplifiers) on each antenna element. These components are used to correct amplitude errors associated with other circuit elements and are also typically used to control the RF amplitude of the RF signal at each antenna element and thus the sidelobe levels.

Further, MIMO phased array antenna systems must use current-hungry digital-to-analog converters (DAC, ADC) and beam processing. Phased array antennas therefore have a complicated hardware architecture and require a lot of power.

Metasurface antennas are also being researched for use in beam steering, beam shaping and multi-beam generation. Metasurfaces are planar 2D structures consisting of an array of metamaterial elements. These metamaterial elements are called unit cells or meta-atoms. Metamaterials are artificial, sub-wavelength structures that enable electromagnetic properties not found in natural materials. Metasurfaces are made by printing very small metal spots (below the wavelength) on a grounded dielectric plate to control the wavefronts radiated by the antenna, preferably without phase shifters and complex structures as in conventional array antennas.

Conventional metasurface structures have a low number of simultaneous beams, limited bandwidth, large or multi-layer structure, low efficiency, unstable beam pattern over the frequency deviation, and non-uniform gain for the radiated beams.

In abstract, conventional phased array antennas have limited suitability to meet the requirements of future communication systems that require a large number of antenna elements to achieve high directivity and multiple beams. This is because the conventional phased array antennas have a complex hardware architecture and high power consumption, as each antenna element in the phased array antenna system requires a phase shift circuit and a power amplifier to compensate for insertion loss.

The invention is now based on the task of solving at least some of the above disadvantages in the prior art, and in particular reducing manufacturing, implementation and/or deployment costs.

### SUMMARY OF THE INVENTION

The purpose of this summary is to present a selection of features and concepts of the invention, which are explained further below in the description. This summary is not intended to identify important or essential features of the claimed subject-matter, nor is it intended to limit the scope of the claimed subject-matter.

According to the invention, the above task is solved by the features of the independent claims.

Specifically, the task is solved by a multi-beam antenna. The multi-beam antenna has a substrate. The multi-beam antenna further has a metasurface on the substrate. The metasurface is adapted to be a matrix with rows and columns of unit cells. The unit cells are of a first type and of a second type. The two types are different from each other. The two types differ in the structure of the metallization. The multi-beam antenna is adapted to radiate phase-adjusted signals in multiple directions simultaneously, based on a periodic arrangement of the unit cells of the first and second types on the substrate.

The invention has the advantage that manufacturing, implementation and/or deployment costs can be reduced due to the simplified structure.

For example, a unit cell can be understood as a cell with a fixed dimension, in particular as a metallized elementary area of the metasurface. The unit cells may therefore be described by their two-dimensional mapping. The unit cells of the first type may have the same size as the unit cells of the second type, differing only in metallization. For example, each unit cell has a substantially rectangular or substantially square shape. In general, the unit cells may have the same dimensions, preferably the same height, width and/or length. The dimensions may be significantly smaller than an operating wavelength, e.g. smaller than 0.25 times (or 0.2 times or 0.15 times or 0.1 times) the operating wavelength. The operating wavelength can correspond to a wavelength for which the multi-beam antenna is designed/impedance-matched, i.e. in particular a center frequency or a carrier frequency.

The periodic arrangement of the unit cells of the first and second types can be understood in such a way that an arrangement pattern of the unit cells of the first and second types is repeated with respect to each other, for example more than once, twice, three times, four times or five times.

Advantageous embodiments of the invention are indicated in the sub-claims.

A part, preferably a majority, of unit cells belonging to the same row may have an electrically conductive connection to each other within an overall area of the metasurface. Another remaining or residual part thereof may, for example, have no electrically conductive connection to each other within the overall area of the metasurface.

All unit cells belonging to the same row may have an electrically conductive connection to one another within an overall area of the metasurface.

All unit cells belonging to different rows, for example, have no electrically conductive connection to each other within the overall area of the metasurface.

In this way, a beam that is narrower in elevation and adjustable in azimuth can be achieved.

In relation to an area of the multi-beam antenna consisting exclusively of the matrix, each unit cell, in particular regardless of its type, of a respective row of the matrix can be electrically conductively connected. For example, a junction of all unit cells adjacent in a respective row of the matrix may be, e.g. exclusively, metallic.

With respect to the region of the multi-beam antenna consisting exclusively of the matrix, each unit cell, in particular of the same type, of a respective column of the matrix may be non-electrically conductively connected. For example, a junction of all unit cells adjacent in a respective column of the matrix, e.g. exclusively, may be free of metal.

The phase-adjusted signals can be in-phase signals. In this way, an explicit radiation pattern can be defined without phase shift. In this case, the multi-beam antenna can explicitly do without active elements.

The phased signals can also be uniformly phase-shifted signals from row to row of the matrix. The term “uniformly” can mean that an equal phase angle can be specified from row to row of the matrix.

This can significantly extend the range of application of the multi-beam antenna.

The multi-beam antenna can be adapted to a flat surface. In particular, the multi-beam antenna may have only the substrate and one or more types of metal. For example, the multi-beam antenna can be a sandwich of a substrate between two metallization surfaces. The upper side of the substrate has a structured metallization and the underside of the substrate has a flat metallization. Other active and passive elements may be missing or not present in the multi-beam antenna.

The metasurface or the unit cells can consist of a single, preferably continuous, metal layer and be printed on the substrate, which is preferably a single layer.

This makes it easy to manufacture the multi-beam antenna.

The multi-beam antenna may have a, e.g. full-surface single, metal surface on the opposite side of the metasurface on the substrate. The metal surface can form a ground (GND).

In this way, a sandwich structure formed by essentially two base elements (substrate and metal) can be adapted to. Thus, only the substrate itself is located between the two metal surfaces on the top and bottom of the substrate.

The unit cells of the first type can be arranged in columns and/or rows alternating with the unit cells of the second type. Each row or column may have the same periodic arrangement pattern as any other row or column of the matrix. Adjacent unit cells may be of different types in the row direction of the matrix. Adjacent unit cells may be of the same type in the column direction of the matrix.

The unit cells of the first type may have a smaller impedance than the unit cells of the second type, for example less than 0.8 times (or 0.75 times or 0.5 times) the impedance of the unit cells of the second type. For example, a metal area of the unit cells of the first type may be larger than a metal area of the unit cells of the second type, for example more than 1.25 times (or 1.5 times) the metal area of the unit cells of the second type. For example, the metasurface of the multi-beam antenna may be structured exclusively of two types of unit cells.

A metallization pattern of the unit cells may be different along each column of the matrix. A metallization pattern of the unit cells may be different along each row of the matrix. This metallization pattern may be constant in the row direction of the matrix and change periodically in the column direction.

One of the columns at the edge of the matrix (outermost column) may have respective feed points corresponding to the row. The number of feed points can correspond to the number of feed points located at the one outer edge of the matrix, e.g. the number of rows. The feed points may be adapted to feed the phase-adjusted signals, preferably into the rows/in sequence/row by row.

The multi-beam antenna can have a single feed port. The feed port can be adapted to feed in a signal on which the phase-adjusted signals are based. The feed port can also be adapted to feed in the phase-adjusted signal. The multi-beam antenna can have a divider device. The splitter device can be adapted to split the signal into the phase-adjusted signals and forward them to the respective feed points. The divider device can also be adapted to forward the phase-adjusted signal to the respective feed points.

In this way, a simple and cost-effective signal feed can be provided to the unit cells.

The feed port can be electrically connected to the feed points via transmission lines. The divider device can consist of N-1 signal dividers, e.g. Wilkinson dividers. N can denote the number of feed points and/or the number of rows of the matrix. To form the in-phase signal, the divider device can include no active elements and connect the feed port to all feed points in an electrically conductive manner, for example impedance-matched. However, the divider device can also have N phase shifters to form the uniformly phase-shifted signals in order to shift the phase of the signal fed in at the feed port uniformly from row to row of the matrix. The phase shifters can be arranged directly downstream of the respective feed points. This means that the phase shifters can be connected downstream of the signal dividers arranged directly upstream of the feed points (last downstream). The phase shifters can be realized by switches with PIN diodes.

In particular, at least some or all of the connecting lines, e.g. the transmission lines, can be printed lines on the substrate in the form of strip lines, for example the connecting lines, e.g. all of them, of the multi-beam antenna located on the substrate. The strip lines can be microstrip lines, symmetrical strip lines, shielded strip lines, coplanar lines and/or double-band lines.

Part or all of the elements of the multi-beam antenna may be printed on one and the same substrate.

Thus, a flat and passive device can be provided to generate multiple beams. Further, simple circuits can be integrated to enable multi-beam control. Space and energy can therefore be saved.

The above task is also solved by a method for manufacturing a multi-beam antenna as described above, for example. The method comprises providing a substrate. The method further comprises providing a metasurface by forming a matrix with rows and columns of unit cells of a first and second type on the substrate. The method further comprises periodically arranging the unit cells of the first and second types on the substrate to enable the multi-beam antenna to radiate phased signals in multiple directions simultaneously.

Manufacturing, implementation and/or deployment costs can generally be reduced.

The above task is also solved by a computer program. The computer program comprises instructions which, when the computer program is executed by a computer, cause the computer to perform the method described above or at least one of the steps thereof. The computer program may be, for example, a module for starting/operating a computer device as described herein.

The above task is also solved by a data carrier. The computer program may be stored on the machine-, processor- or computer-readable data carrier, for example on a permanent or rewritable storage medium. This also includes that the computer program may be provided on a server or a cloud server for downloading, for example via a data network such as the Internet or a communication link such as a wireless connection.

In other words, the invention relates to a multibeam metasurface antenna based on a single substrate layer and a feed port. The multibeam metasurface antenna can thus generate up to eleven simultaneous beams with just one feed port. The overall design of the multibeam metasurface antenna can be passive and not include phase shifters, for example. The multi-beam metasurface antenna can consist of a flat, single-layer substrate. The substrate can be easily realized using standard PCB technology.

Various antennas have been created for some frequencies in the millimeter wave range (from 20 GHz to 40 GHz), which can radiate two to eleven simultaneous beams depending on the adjustment of parameters (metallization, basic shape, unit cell size, unit cell metallization per type, substrate thickness, substrate type, etc.).

All beams can have approximately the same high gain. In addition, other practical beam shapes can be achieved by designing the geometry of the metasurface. For example, narrow pencil beams, fan beams, simultaneous endfire and backfire beams and narrow hemispherical beams that can cover 180° with a constant gain in azimuth can be created. Any number of simultaneous beams (more than twenty-five beams) can also be achieved if more than one feed port is used.

The concept can be explicitly extended to 2.6 GHz and 6 GHz bands. At least two simultaneous beams can be achieved in each band.

This multi-beam metasurface antenna can be combined with various base stations and portable transmitting and receiving devices, e.g. cell phones or radars. The multi-beam metasurface antenna can thus be used, for example, in 4G, 5G and 6G communication systems, radar, motor vehicles, energy harvesting, reconfigurable smart surfaces and imaging, including security control systems and medical diagnosis.

The time to market of a product with such a multi-beam metasurface antenna can be expected to be short, as it can achieve a lower C-SWaP (cost, size, weight and power consumption) than current commercial antennas.

In still other words, the invention describes a flat structure based on passive elements that can generate multiple beams simultaneously without using complex RF circuits such as phase shifters, power amplifiers and/or beamformers as in phased array antenna systems. The flat structure is based on the metasurface principle, where the unit cells are designed and optimized to affect the dispersion characteristics of surface waves. The surface impedance of these unit cells is periodically modulated, resulting in the conversion of surface waves into leakage waves and, depending on the desired radiation pattern, into free-space waves.

In the application, the radiation pattern of the present multi-beam antenna may be adapted to generate multiple narrow beams, where each beam can cover a certain floor of a building. In addition, each beam can provide 180° coverage in the azimuth plane to cover the same floors of many buildings simultaneously with good gain. Thus, the mobile operator can offer more data capacity and reduce many resources such as space and power. In addition, the radiation pattern can be adapted to the needs of users, so it can be used in many scenarios, such as hotspots, indoor and rural areas.

Another application for the multi-beam metasurface antenna can be energy harvesting. For example, when the portable devices are in sleep mode, they can receive multiple RF signals from the environment via the simple passive multi-beam metasurface antenna while maintaining high gain. This technology can generate more energy than conventional antennas.

The overall structure can therefore be cost-effective, simple, thin, planar and passive.

The multi-beam antenna can be easily adapted according to the requirements in terms of the number of simultaneous beams and the possible beam patterns.

The simultaneously generated beams of the multi-beam antenna can have uniformly high gain and low sidelobe values. In addition, the radiation pattern can be stable over a wide frequency range, which is desirable in mobile network systems.

Since the structure is planar, dynamic formation of multiple beams can be enabled by integrating active elements in the unit cells, such as diodes, transistors, varactors and switches. The multi-beam antenna can be provided monolithically or hybrid on the substrate, which forms the core layer of the printed circuit board, also known as the PCB. The elements optionally used for the multi-beam antenna can be surface-mounted devices (SMDs). SMD components are soldered directly onto the PCB using solderable connection surfaces (flat module). The associated technology is surface-mounting technology (SMT). As an alternative or in addition to the SMD components that do not have wire connections, the elements optionally used for the multi-beam antenna can be wired components that are attached using through-hole technology (THT).

The core layer of the printed circuit board can consist of electrically insulating material. Conductive connections or conductor paths (for example on the multi-beam antenna 1 itself) can adhere to one side of the electrically insulating material. The other side of the electrically insulating material can be a continuous conductive surface, which can form the ground (GND) of the printed circuit board. The insulating material can be fiber-reinforced plastic or hard paper. The conductive traces/metallizations may be etched from a layer of metal, such as copper, for example with a thickness in the range of 20 to 35 μm.

The designed multi-beam antenna can be compatible with current phased array antenna system such as Massive MIMO, i.e. each array of unit cells (which can also be considered as an array element) can be fed separately to achieve beam steering function and generate desired beam patterns. This can reduce the complexity of conventional beamforming circuits and their power consumption, as each array of unit cells can generate many beams simultaneously.

Although some of the foregoing aspects are described with respect to the multi-beam antenna, these aspects may also apply to the method. Likewise, the aspects described above in relation to the method may apply to the multi-beam antenna in a corresponding manner.

All technical and scientific terms used herein have the meaning that corresponds to the general understanding of the skilled person in the technical field of antenna technology; they are to be interpreted based on the definitions to be found in the dictionary or the technical jargon relating to this technical field. If technical terms are used incorrectly in the present case and thus do not express the technical idea of the present invention, they can be replaced by technical terms that convey a correct understanding to the skilled person.

The terms “first”, “second” are merely intended to distinguish components from one another. For example, a first component can be referred to as a second component and a second component as a first component.

If it is meant here that a component is “connected” to another component, this can mean for the purpose of the present disclosure that these components can also be directly connected to one another. The term “directly” indicates that there is no other component in between.

The method steps described herein should not be construed herein as having to be performed in any particular order, unless expressly or implicitly indicated otherwise, for example if these method steps cannot be interchanged for technical reasons. The method steps may also be carried out directly one after the other (without further intervening steps) and/or consecutively.

### BRIEF DESCRIPTION OF THE DRAWINGS

Further objectives, features, advantages and possible applications are shown in the following description of embodiments, which are not to be understood as limiting, with reference to the associated drawings. The same or similar elements in the drawings are always marked with the same or similar reference numbers. Detailed explanations of known functions and structures are omitted insofar as they detract from the invention.

The drawings show in:

FIG. 1 a principle of the multi-beam antenna described herein;

FIG. 2 a plan view of a multi-beam antenna according to a first embodiment;

FIG. 3 a plan view of a multi-beam antenna according to a second embodiment;

FIG. 4 a schematic representation of the method of manufacturing the multi-beam antenna; and

FIG. 5 a view of a computer used in the manufacture of the multi-beam antenna.

### DETAILED DESCRIPTION

The multi-beam antenna and the method of manufacturing the same will now be described with reference to the embodiments. Without being limited to this, specific details are explained in order to provide a deeper understanding of the invention.

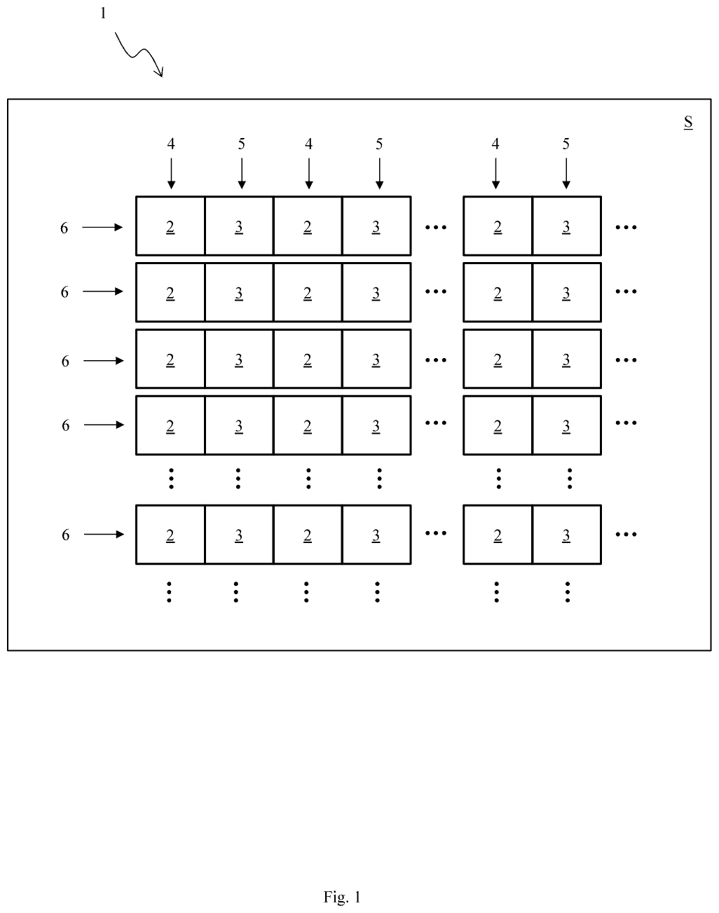

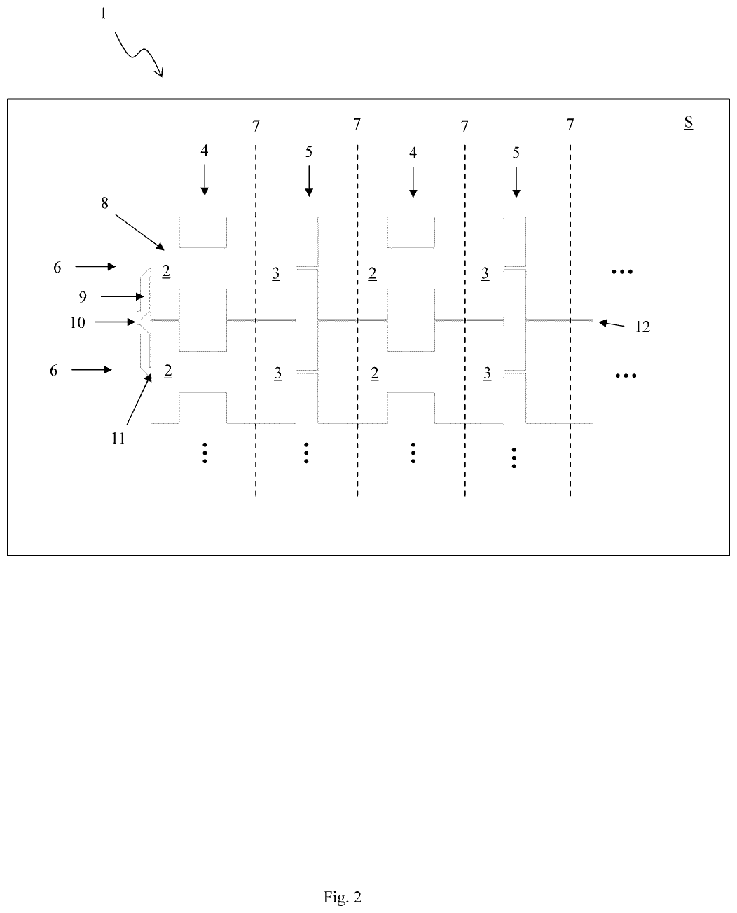

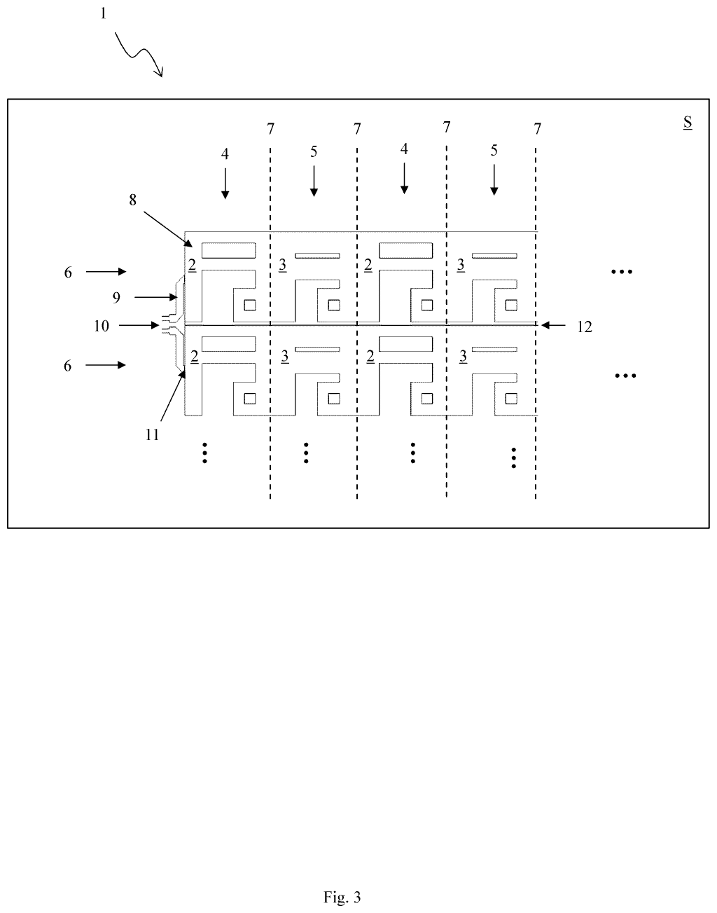

FIGS. 1 to 3 schematically show respective multi-beam antennas 1, where FIG. 1 is intended to illustrate the essential basic principle of the multi-beam antenna 1 and the multi-beam antenna 1 of FIGS. 2 and 3 are each intended to represent an example of an implementation.

Thus, the multi-beam antenna 1 essentially has two different components, the substrate S and a metallization 8 on the upper side and the lower side of the substrate S. The metallization on the lower side of the substrate S (the plane not visible in FIGS. 1 to 3) can be fully metallized in order to form a mass for the multi-beam antenna 1. The metallization 8 on the top surface of the substrate S may be formed in the form of a matrix in which at least two different types 2, 3 of unit cells are adapted to be formed. The different types 2, 3 of unit cells are arranged along each row alternately or with a different period shape. Each row forms a continuous electrically conductive surface. Each row is essentially a copy of every other row. The rows may be insulated from each other, at least with respect to an area formed by the matrix, as an electrical connection may be adapted to be formed outside the matrix area by the divider device referred to herein. The periodic arrangement of the columns 4, 5 is shown schematically. In FIGS. 2 and 3, the various columns 4, 5 are each divided by a dash 7 in the column direction in order to better distinguish the unit cells 2, 3. Furthermore, in FIGS. 2 and 3, a row insulation 12 is shown in the row direction, which is present between respective rows 6 in order to isolate them from each other in the matrix area.

The power is fed in via transmission lines 9, which can be impedance-matched. The smallest conductor spacing 10 between respective transmission lines 9 coupled directly to adjacent feed points 11 can be greater than a smallest respective spacing of the transmission lines 9 in an area directly in front of the corresponding feed point 11, in which the transmission line 9 runs adjacent and parallel to an edge of the corresponding unit cell 2.

The examples of metallizations 8 on the upper surface of the substrate S in FIGS. 2 and 3 can be abstracted from FIG. 1, at least in their basic principle.

The metallization 8 in FIG. 2 shows the two different types 2, 3 of unit cell, in which the first type 2 of unit cell has a larger metal area than the second type 3 of unit cell. This is exemplified by the web of the unit cell of the first type 2 compared to the web of the unit cell of the second type 3. As a result, the impedance of the unit cell of the second type 3 is more than 2 times (or 3 times) as high as the impedance of the unit cell of the first type 2. Here, the metallization of both types 2, 3 can be described by an H-shape, in which the two parallel areas are connected by means of the different web corresponding to the type. The web of the second type 3 is at least 2 times (or 3 times or 4 times) as small as the web of the first type 2, with corresponding parallel areas of the H-shaped unit cells of the first 2 and second 3 types touching each other.

The metallization 8 in FIG. 3 is similar to the metallization 8 in FIG. 2 in that corresponding webs (although not H-shaped) between corresponding unit cells of the first 2 and second 3 types have different sizes. In the case of FIG. 3, it is the reverse of FIG. 2 in that in FIG. 3 the first type 2 of unit cells have a greater impedance than the second type 3 of unit cells. However, the connection at the respective dashes 7 in FIG. 3 behaves in the same way as the connection at the respective dashes 7 in FIG. 2, where the junction between each unit cell in a row 6 of the matrix is metallic. In other words, there are no joints at the junction or the junction is smooth or invisible.

For the task in FIGS. 1 to 3, it can be abstracted that the width of the metallization 8 of the corresponding unit cells 2, 3 can be preset in the direction of wave propagation in order to achieve a desired radiation pattern. For this purpose, the different unit cells 2, 3 can have webs of different widths (which extend in the wave propagation direction or row direction of the matrix) or the width of the webs can be preset/preset. The number of webs within a unit cell can be at least one. As can be seen in FIG. 3, the number of webs can also be two or more. The type and appearance of the ridges can be determined by the impedance of the unit cell(s)-measured in the row direction. Thus, unit cells of first 2 and second 3 type can be selected which have a corresponding impedance pattern to each other in order to achieve a desired radiation characteristic.

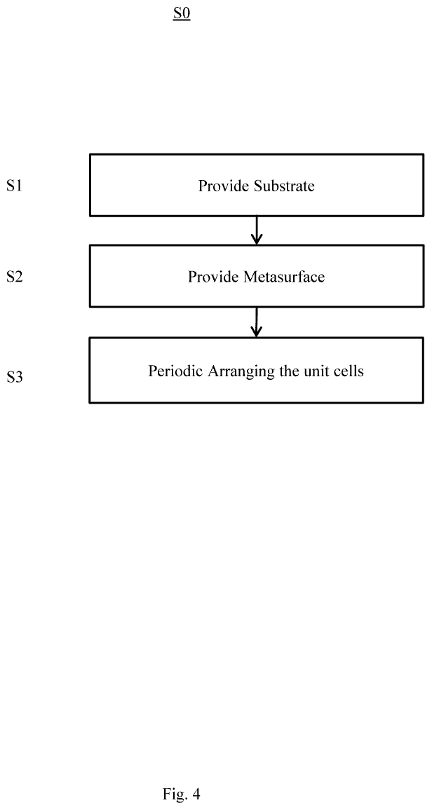

FIG. 4 shows a schematic representation of the method S0 for manufacturing the multi-beam antenna 1. The method S1 comprises providing S1 the substrate S. The method S0 comprises providing S2 the metasurface by forming the matrix with the rows 6 and the columns 4, 5 from the unit cells of the first type 2 and the second type 3 on the substrate S. The method SO further comprises periodically arranging S3 the unit cells of the first type 2 and the second type 3 on the substrate S to enable the multi-beam antenna 1 to radiate the phased signals in the multiple directions simultaneously.

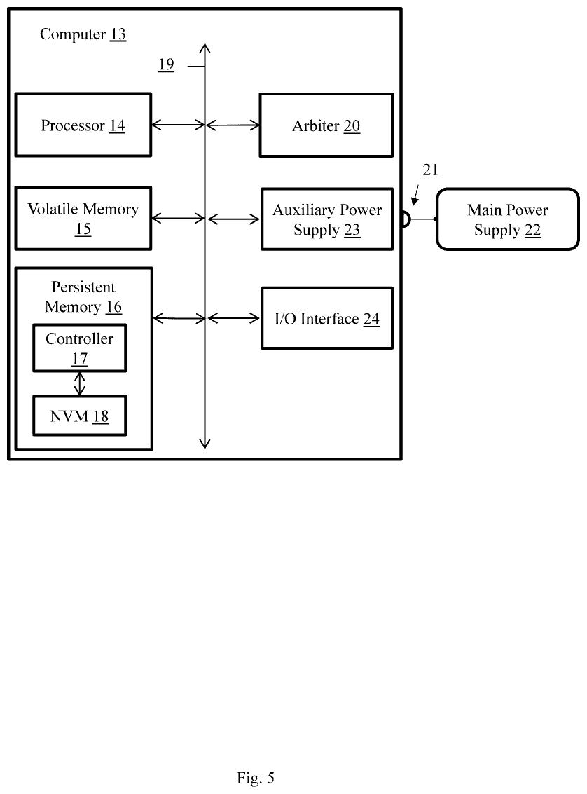

The method steps shown as blocks of the block diagram in FIG. 4 may, for example, be substantially mapped in a machine-, processor-or computer-readable medium and thus performed by a computer 13 or processor 14 as described, for example, below with reference to FIG. 5. Examples may further be or refer to a computer program that includes program code for performing at least a portion of the method steps of FIG. 4, when the computer program is performed on the computer 13 or processor 14. An example may also have a non-volatile memory or non-volatile memory 16, such as also described below with reference to FIG. 5, which is machine-, processor-or computer-readable and encodes machine-executable, processor-executable or computer-executable programs with instructions to cause some or all of the method steps to be performed.

FIG. 5 schematically shows a block diagram representing a computer 13. The computer 13 may, for example, describe at least part of a computer device used to manufacture the multi-beam antenna 1.

The computer 13 implements one or more steps of the method SO for manufacturing the multi-beam antenna, as represented in FIG. 4. In particular, the computer 13 provides functionality, such as computer software, that runs on the computer 13 and performs one or more steps of the method SO. In particular, the computer 13 may execute instructions related to the DATA required to manufacture the multi-beam antenna 1 included in the computer program described herein and cause the computer 13 to perform the one or more steps of the method SO. In the DATA required for manufacturing the multi-beam antenna 1 (hereinafter referred to as the manufacturing data), setting parameters such as metallization, base shape, unit cell size, unit cell metallization per type, substrate thickness, substrate type, etc., may be included.

As provided herein, the computer 13 may take any suitable physical form. As an example, the computer 13 may be adapted to be, at least in part, an embedded computer, system-on-chip (SOC), single board computer (SBC), server, and/or user equipment (UE). The computer 13 may be unitary or distributed; span one or more locations; span one or more machines or data centers; or be arranged in a cloud, which may have cloud components in a network. The computer 13 may perform one or more steps of the method S0 without significant spatial or temporal limitations. As an example, the computer 13 may perform one or more steps of the method S0 in real time, in parallel, or in batch mode. The computer 13 may perform step(s) of the method S0 at different times or locations.

The computer 13 has at least one or more of the following components: a processor 14, a volatile memory 15, a non-volatile memory 16 with controller 17 and non-volatile memory device (NVM) 18, a bus 19, an arbiter 20, a power connector 21, a main power supply 22, and an auxiliary power supply 23, and an input/output (I/O) interface 24. The components of the computer 13 may be performed at least partially in hardware and/or software. The interconnection of the components of the computer 13 is structured as in FIG. 3 merely for the sake of simplicity. In particular, the interconnection and connection can differ in the implementation due to signal processing and signaling. In FIG. 5, it is shown by way of example that the main power supply 22 is external devices. This component can of course also be part of the computer 13 itself.

The processor 14 has means for performing instructions associated with the manufacturing data, for example, the computer program described herein. For example, the processor 14 may load the instructions associated with the manufacturing data included in the computer program described herein from, for example, the volatile memory 15 and/or the non-volatile memory 16 and then execute the instructions, which in turn causes the processor 14 to perform the one or more steps of the method SO as represented, for example, in FIG. 4. The processor 14 may have an internal register/cache for the manufacturing data, for instructions associated with the manufacturing data, and/or for associated addresses. The processor 14 may have an FPLA, an FPGA, a microcontroller, a CPU, a GPU, an ASIC, and/or a DSP for accessing the internal register/cache. As an example, to perform the instructions associated with the manufacturing data, the processor 14 may fetch the instructions from the internal register/cache of the processor 14, the volatile memory 15, or the non-volatile memory 16; decode and perform; and then write a result to the internal register/cache of the processor 14, the volatile memory 15, or the non-volatile memory 16.

As an example, the processor 14 may have an instruction cache, a data cache, and/or a translation buffer (TLB). The instructions associated with the manufacturing data in the instruction cache may be copies of instructions in the volatile memory 15 and/or non-volatile memory 16, and the instruction cache may accelerate fetching of these instructions associated with the manufacturing data by the processor 14. The manufacturing data in the data cache may be copies of data for the instructions currently executing on the processor 14 and related to the manufacturing data in the volatile memory 15 and/or non-volatile memory 16. The results of previous instructions performed on the processor 14 and related to the manufacturing data, may be provided for access by subsequent instructions to be performed on the processor 14 and related to the manufacturing data, or for writing to the volatile memory 15 and/or non-volatile memory 16. The data cache may accelerate the read or write operations of the processor 14. The addresses in the TLB associated with the manufacturing data may be address references to addresses in the volatile memory 15 and/or non-volatile memory 16 to accelerate virtual address translation for the processor 14.

The volatile memory 15 may be a dynamic RAM (DRAM) or a static RAM (SRAM). In particular, the volatile memory 15 may be adapted to be the data carrier described herein on which the computer program described herein may be at least temporarily stored. In addition, the volatile memory 15 may be a single or multi-channel RAM. The volatile memory 15 may have a main memory for storing instructions associated with the manufacturing data for the processor 14, which then performs those instructions; or the manufacturing data for the processor 14 to use to operate with. As an example, the computer 13 may load these instructions from the non-volatile memory 16 or another source (such as another computer, the network, or the cloud) into the volatile memory 15. The processor 14 may then load these instructions from the volatile memory 15 into the internal register/cache of the processor 14. In order to perform these instructions, the processor 14 may fetch and decode these instructions from the corresponding internal register/cache. During or after performing these instructions, the processor 14 may write a result (which may be intermediate or final results) to the internal register/cache. The processor 14 may then write the result to the volatile memory 15.

For example, the processor 14 performs only the instructions associated with the manufacturing data in the internal register/cache of the processor 14 or in the volatile memory 15 (as opposed to the non-volatile memory 16), and operates only on the manufacturing data in the internal register/cache of the processor 14 or in the volatile memory 15 (as opposed to the non-volatile memory 16). A memory management unit (MMU—not shown) may be located between the processor 14 and the volatile memory 15, and may support access requested by the processor 14 associated with the manufacturing data to the volatile memory 15.

The volatile memory 15 may be a memory shared by the processor 14 and the I/O interface 24. The I/O interface 24 thereby accesses the shared volatile memory 15 via the processor 14. For example, the I/O interface 24 may not include a built-in memory. Here, the I/O interface 24 may share the volatile memory 15 connected to the processor 14. The processor 14 may have a memory access path that provides access to the shared volatile memory 15 associated with the manufacturing data. The I/O interface 24 access the shared volatile memory 15 via the memory access path of the processor 14. The I/O interface 24 is enabled to access the shared volatile memory 15 associated with the manufacturing data while the memory access path is active and the processor 14 is inactive. Here, the memory access path is active without intervention of the processor 14. The memory access path is switched off while the processor 14 and the I/O interface 24 are inactive. The memory access path is turned on without intervention of the processor 14 as soon as a request to couple the memory access path to the processor 14 is received while the memory access path is turned off and the I/O interface 24 is active.

The non-volatile memory 16 has a mass storage device, such as a non-volatile memory (NVM) 18 for the manufacturing data or the instructions associated with the manufacturing data. In particular, the non-volatile memory 16 may be adapted to be the data carrier described herein, on which the computer program described herein may be stored. As an example, the non-volatile memory 16 may be a solid state disk (SSD), a flash memory, a non-volatile memory card, a secure digital memory card (SD), an embedded multi media card (eMMC), and/or a universal serial bus (USB). The non-volatile memory 16 may store the manufacturing data in an erasable or non-erasable manner. The non-volatile memory 16 may be located within the computer 13, i.e. internal, or external thereto. The non-volatile memory 16 may have the controller 17 that supports communication for passing the manufacturing data between the processor 14 and the non-volatile memory 16, in particular the NVM 18 of the non-volatile memory 16.

For example, the NVM 18 may be an NVM package comprising a buffer chip and NVM chips. The NVM chips each have a status output pin. The controller 17 controls the NVM chips and has a first pin. The buffer chip is connected between the controller 17 and the NVM chips. The buffer chip has a second pin, which outputs an external status signal to the first pin of the controller 17, and a third pin, which receives internal status signals indicating the respective states of the NVM chips from the status output pins. Further, the buffer chip outputs the external status signal with a specified time period based on the internal status signals. The specified time period can be a duty cycle. The internal state signals indicate either a first or second state. The duty cycle of the external state signal is determined depending on an identifier (ID—e.g., initialized when the computer 13 is started) of the one or more NVM chips that output the internal state signal indicating the first state among the NVM chips. The controller 17 receives the external state signal from the buffer chip. The controller 17 provides a status read command not to the NVM chips based on the external status signal, and a write/read command to at least one of the NVM chips by the buffer chip based on the specified period or duty cycle included in the external status signal. The controller 17 writes/reads the manufacturing data to/from the NVM chips that receive the write/read command through the buffer chip.

A method for rearranging the manufacturing data may be used in the non-volatile memory 16. Here, a stack of the manufacturing data is reordered using one of the NVMs 18 at a level of the NVM hierarchy. The reordering comprises streaming a portion of the batch of manufacturing data and retrieving another portion of the batch of manufacturing data in parallel with streaming the one portion of the batch of manufacturing data. The thus rearranged stack (which is composed of the one part and the other part) is then stored in another NVM of the NVM 18 at another level of the NVM hierarchy.

The processor 14 may be connected to the non-volatile memory 16 directly or indirectly, for example via an internal host controller (not shown). The connection can be made via a clock bus, command bus and data bus. This is only shown schematically using the bus 19 in FIG. 5. In the case of a separate host controller, this is electrically connected to the processor 14 and to the non-volatile memory 16. The host controller is preferably part of the processor 14. The non-volatile memory 16 receives commands associated with the manufacturing data and the manufacturing data in connection with a clock signal that is specified by the processor 14 or the host controller on the clock bus. Here, the clock signal clocks the receipt of the instructions associated with the manufacturing data and the manufacturing data. The processor 14 or the host controller transmits a command related to the manufacturing data to the non-volatile memory 16 via the command bus. Further, the processor 14 or the host controller transmits the manufacturing data corresponding to the command to the non-volatile memory 16 via the data bus or receives the manufacturing data from the non-volatile memory 16 via the data bus. Further, the processor 14 or the host controller transmits another command related to the manufacturing data to the non-volatile memory 16 via the command bus while or before transmitting the manufacturing data. The one instruction is an instruction associated with the manufacturing data and the other instruction is an instruction not associated with the manufacturing data. The processor 14 or the host controller transmits the further command when the non-volatile memory 16 is in an active state. The active state of the non-volatile memory 16 is indicated by the data bus. In the active state, the manufacturing data may be held in a data buffer (e.g. as part of the buffer chips-not shown) of the non-volatile memory 16 by means of the further command from the NVM 18 of the non-volatile memory 16 in order to retrieve the manufacturing data faster with another command.

In one example, the NVM 18 may have a clock pin through which the clock signal is received from the controller 17 of the non-volatile memory 16. The clock signal may be a write enable signal and/or read enable signal. The NVM 18 may further have first and second I/O pins. The manufacturing data is received by the controller 17 of the non-volatile memory 16 in synchronization with the clock signal via the first I/O pin. The NVM 18 may further have a command/address buffer (e.g., as part of the buffer chip), a memory cell array (e.g., as part of the NVM chips-not shown), and control logic (not shown). The command/address buffer operates at a first operating speed and buffers, in synchronization with the clock signal, the command and corresponding address received via the second I/O pin and associated with the manufacturing data. The NVM 18 may further have an I/O buffer (e.g., as part of the buffer chip) that operates at the first operating speed and buffers the manufacturing data as read data from the memory cell array or writes the manufacturing data as write data to the memory cell array. The first and second I/O pins can coincide. Here, the clock signal may be formed by a first and second clock signal in which the first clock signal switches only in a period in which the command and the address (both related to the manufacturing data) are received from the controller 17, and the second clock signal switches only in a period in which the manufacturing data is received from the controller 17. The first operation speed corresponds to a data input speed or data output speed between the NVM 18 and the controller 17 of the non-volatile memory 16. The control logic controls an operation with respect to the memory cell arrangement based on the buffered instruction and the buffered address (both related to the manufacturing data). Here, the control logic operates at a second operation speed which is lower than the first operation speed. The second operating speed corresponds to an internal operating speed of the NVM 18.

The bus 19 herein can be understood as a subsystem of the computer 13, which transfers the manufacturing data and/or electrical power between the components of the computer 13. The (one) bus 19 may thereby connect the components of the computer 13 via the same set of wires. The bus 19 may be adapted to dedicated communication of manufacturing data between two or more of the components of the computer 13. The bus 19 may have a ring topology, star topology, (partially) meshed topology, bus topology, tree topology and/or line topology. The bus 19 may have one or more of the following bus types: Accelerated Graphics Port (AGP), HyperTransport (HT), Industry Standard Architecture (ISA), Peripheral Component Interconnect (PCI), PCI-Express (PCIe), Serial Advanced Technology Attachment (SATA) and/or INFINIBAND.

The bus 19 can be a system bus via which the processor 14 is connected to the other components of the computer 13. Here, the bus 19 can be synchronous-the transfer of the manufacturing data takes place bidirectionally with a clock edge of a clocking of the bus 19—and/or asynchronous—no clocking, but a handshake takes place for the transfer of the manufacturing data. In such a semi-synchronous system bus, the bus 19 is clocked, but control lines enable wait cycles in order to also use slow components such as the non-volatile memory 16 via the bus 19.

The arbiter 20 may be provided for at least partial control over the bus 19. The arbiter 20 can be understood as a coprocessor ancillary to the processor 14. Based on a two-way handshake or three-way handshake, the arbiter 20 controls the access to the bus 19 associated with the manufacturing data. For this purpose, the three signals bus request (BREQ) for forwarding the manufacturing data, bus grant (BGRT) for confirming and approving the forwarding and bus grant acknowledge (BGA) for optional forwarding feedback are used. The arbiter 20 simultaneously receives several BREQs from different components of the computer 13 via the bus 19. The arbiter 20 sorts the BREQs according to priority and forwards them sequentially—in a pipeline—to the processor 14. As soon as the processor 14 has received the BREQ, the processor 14 transmits the BGRT to the arbiter 20 or directly to the component of the computer 13 transmitting the BREQ. A lower priority BREQ of the BREQs in the pipeline—e.g., from another component of the computer 136—is forwarded to the processor 14 in response to a BGRT sent by the processor 14 with respect to the BREQ having priority in the pipeline and associated with at least a portion of the manufacturing data. The BGRT related to the lower priority BREQ is transmitted from the processor 14 to the arbiter 20 after processing the at least a portion of the manufacturing data. The arbiter 20 may, for example, in response to the BGRT relating to the lower-ranking BREQ, in turn transmit a further lower-ranking BREQ in the pipeline-relating, for example, to another part of the manufacturing data—of the BREQs to the processor 14. Similarly, in response to each BGRT from the processor 14, the arbiter 20 may transmit a respective related BGA to the processor 14. With the procedure described herein, a BGA can also be omitted altogether. This saves overhead in the communication between the components of the computer 13, that is, a two-way handshake is provided instead of a three-way handshake.

The bus 19 can also have a data bus, address bus and control bus. Here, the manufacturing data is transmitted bidirectionally between the components of the computer 13 via the data bus. The address bus is operated solely by the processor 14 and transmits memory addresses related to the manufacturing data unidirectionally. The control bus is controlled solely by the arbiter 20, e.g. in the sense of a monitor, and transfers control thereof to the processor in the pipeline-like manner as described above to control the transmission of the manufacturing data.

The power connector 21 may be arranged at a dedicated connection point on a housing of the computer 13. The power connector 21 may represent a central power supply point for the components of the computer 13, and connects the computer 13 or its components to the main power supply 22. In the case of an integrated main power supply 22, the power connector 21 may be an integral part of the computer 13 or the main power supply 22.

The main power supply 22 supplies at least one or more of the components of the computer 13 with electrical power, for example via the bus 19. In particular, the main power supply 22 charges the auxiliary power supply 23 with electrical power, for example from outside the computer 13, for example in the case where the main power supply 22 is connected to a power source outside the computer 13. Here, the main power supply 22 may represent a preferred component used for powering the components of the computer 13 and may have, for example, an accumulator or a battery. The main power supply 22 may have other components such as voltage regulators, DC voltage stabilizers, series regulators, buck converters and/or boost converters to meet the corresponding requirements of the components of the computer 13. Here, the main power supply 22 may have either a dedicated fixed power connector to the power source, such as a power grid, or a detachable power supply connection for charging the accumulator or battery of the main power supply 22. To this end, the main power supply 22 may have an inverter to provide a predetermined DC power supply from an external AC power source as the power source, the DC power supply then being supplied to the components of the computer 13 via the above-mentioned voltage regulators.

The auxiliary power supply 23 is connected to the volatile memory 15 and/or the non-volatile memory 16 via the bus 19. The auxiliary power supply 23 is charged by the electrical power of the main power supply 22. The auxiliary power supply 23 may be located inside or outside the computer 13, or inside or outside the volatile memory 15 and/or the non-volatile memory 16. For example, the auxiliary power supply 23 may be accommodated on a motherboard of the computer 13 to provide auxiliary power to the volatile memory 15 and/or the non-volatile memory 16. In particular, the auxiliary power supply 23 may be performed in the form of a supercapacitor, an accumulator and/or a battery. The power capacity/energy capacity of the main power supply 22 may be many times greater, for example at least 10 times or 50 times greater, than the power capacity/energy capacity of the auxiliary power supply 23.

The processor 14 monitors changes in the electrical power supplied by the main power supply 22. In the event of a sudden power failure, such as when the power source external to the computer 13 is disconnected from the main power supply 22 or the main power supply 22 degrades or fails for some other reason, and the processor 14 determines that the electrical power supplied by the main power supply 22 to one or more of the components of the computer 13 has fallen below a threshold value, such as 0.8 or 0.75 of an operating power of the main power supply 22, the processor 14 causes the auxiliary power supply 23 to take over a remaining supply power for a shutdown operation of the computer 13. The shutdown operation comprises supplying power to at least the processor 14, the volatile memory 15 and/or the non-volatile memory 16 with electrical power for the time of the shutdown operation. During the shutdown process, the manufacturing data currently located in the volatile memory 15 and/or the manufacturing data currently being processed in the processor 14, for example in the register/cache of the processor 14, are transferred from the volatile memory 15 and/or the processor 14 to a meta area of the non-volatile memory 16. For this purpose, the meta area of the non-volatile memory 16 can be reserved especially for the shutdown process.

The processor 14 loads the manufacturing data from the meta area of the non-volatile memory 16 in the event of a startup operation of the computer 13, in which the main power supply 22 again provides the operating power, in order to enable faster data processing. After the startup process, the meta area of the non-volatile memory may be enabled or successively enabled during the startup process.

The I/O interface 24 can enable user interaction with the computer 13. In particular, the manufacturing data or the corresponding parameters can be entered via this interface. The I/O interface 24 may have a device and/or software driver that enables the processor 14 to control the I/O interface 24 to retrieve the setting parameters or manufacturing data and provide them to the components of the computer 13.

In abstract, the invention will simplify the installation of cellular networks. It will help to make cities more environmentally friendly by reducing power consumption and reducing or eliminating the visual pollution caused by large antenna masts. Many cell phone manufacturers could take advantage of this technology to save on size, cost and power. In addition, the invention could be used in many other applications such as radar systems, imaging, motor vehicles, vehicle sensors and energy harvesting.

At this point, it should be noted that all of the parts described above are claimed as essential to the invention when considered alone and in any combination, in particular the details shown in the drawings. Modifications thereof are familiar to the skilled person.

1. A multi-beam antenna comprising:
a substrate;
a metasurface on the substrate, which is formed as a matrix with rows and columns of unit cells of a first and second type,
wherein the multi-beam antenna is adapted to radiate phase-adjusted signals in multiple directions simultaneously, based on a periodic arrangement of the unit cells of the first and second types on the substrate.

2. The multi-beam antenna according to claim 1, wherein
a part, preferably a majority, of unit cells belonging to the same row have an electrically conductive connection to each other within an overall area of the metasurface and another remaining part thereof has no electrically conductive connection to each other within the overall area of the metasurface, or
all unit cells belonging to the same row have an electrically conductive connection to each other within an overall area of the metasurface; and
all unit cells belonging to different rows have no electrically conductive connection to each other within the overall area of the metasurface.

3. The multi-beam antenna according to claim 1, wherein the multi-beam antenna- is adapted to be planar, and the metasurface or the unit cells consists of a metal layer and is printed on the substrate.

4. The multi-beam antenna according to claim 1, wherein the multi-beam antenna has a metal surface on the opposite side of the metasurface on the substrate and the metal surface forms a mass.

5. The multi-beam antenna according to claim 1, wherein:
the unit cells of the first type are arranged column-wise and/or row-wise alternating with the unit cells of the second type; and/or
adjacent unit cells in a row direction of the matrix are of different types, and adjacent unit cells in a column direction of the matrix are of a same type.

6. The multi-beam antenna according to claim 1, wherein:
one of the columns at an edge of the matrix has respective feed points corresponding to the row, which are adapted to feed in the phase-adjusted signals; and/or
the multi-beam antenna comprising:
a single feed port adapted to: feed a signal on which the phase-adjusted signals are based or feed the phase-adjusted signal; and
a divider device adapted to: divide the signal into the phase-adjusted signals and forward them to the respective feed points, or forward the phase-adjusted signal to the respective feed points.

7. The multi-beam antenna according to claim 1, wherein part or all of the multi-beam antenna is printed on the same substrate.

8. A method for manufacturing a multi-beam antenna according to claim 1, the method comprising:
providing a substrate;
providing a metasurface by forming a matrix comprising rows and columns of unit cells of a first and second type on the substrate; and
periodically arranging the unit cells of the first type and the second type on the substrate to enable the multi-beam antenna to radiate phase-adjusted signals in multiple directions simultaneously.

9. A computer program comprising instructions which, when the computer program is executed by a computer, cause the computer to perform the method according to claim 8 or at least one of the steps thereof.

10. A data carrier, wherein the computer program according to claim 9 is stored on the data carrier.
